(19) United States
(12) Patent Application Publication
(10) Pub. No.: US 2015/0171471 A1
(43) Pub. Date: Jun. 18, 2015

(54) LITHIUM BATTERY AND ELECTROLYTE ADDITIVE FOR LITHIUM BATTERY

(71) Applicant: National Taiwan University of Science and Technology, Taipei (TW)

(72) Inventors: Atetegeb Meazah Haregewoin, Taipei (TW); Sheng-Diann Lin, Taipei (TW); Ermias Girma Leggesse, Taipei (TW); Chih-Chiang Chiang, Taipei (TW); Bing-Joe Hwang, Taipei (TW)

(21) Appl. No.: 14/469,600

(22) Filed: Aug. 27, 2014

(30) Foreign Application Priority Data
Dec. 18, 2013 (TW) 102146897

(51) Int. Cl. H01M 10/0567; H01M 10/052

(52) U.S. Cl. CPC H01M 10/0567; H01M 10/052; H01M 4/587

(57) ABSTRACT

A lithium battery is provided. The lithium battery includes an anode, a cathode, a separation film, and an electrolyte solution. The cathode and the anode are disposed separately. The separation film is disposed between the cathode and the anode. The electrolyte solution includes an organic solvent, a lithium salt, and an electrolyte additive. The electrolyte additive includes a compound represented by formula (1):

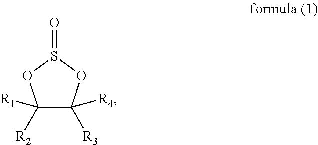

wherein R₁, R₂, R₃, and R₄ are independently a hydrogen atom, a halogen atom, or C1-C3 haloalkyl group, and at least one of R₁, R₂, R₃, and R₄ is a halogen atom or C1-C3 haloalkyl group.

### CROSS-REFERENCE TO RELATED APPLICATION

This application claims the priority benefit of Taiwan application serial no. 102146897, filed on Dec. 18, 2013. The entirety of the above-mentioned patent application is hereby incorporated by reference herein and made a part of this specification.

### BACKGROUND OF THE INVENTION

1. Field of the Invention

The invention generally relates to a battery and an additive, and more particularly to a lithium battery and an electrolyte additive used for a lithium battery.

2. Description of Related Art

Since primary batteries are not environment-friendly, secondary lithium batteries has become a battery system that captures a lot of attention in recent years due to its advantageous characteristics such as light in weight, high energy density, high operating voltage, low self-discharge rate, and long storage life. The secondary lithium batteries are widely used in portable electronic application products such as mobile phones, tablet PCs, and digital cameras.

However, in current secondary lithium batteries, the commonly used electrolyte solution system still encompasses problems such as irreversible capacity, temperature limitation, or safety issues that still have to be overcome. For instance, propylene carbonate (PC) is one of the commonly used solvents in the electrolyte solution system, and PC has advantages such as low cost, low melting point, high ionic conductivity, high dielectric constant, high chemical stability, and high optical stability, etc. Nevertheless, when the electrolyte solution with PC as the only solvent is being used in the secondary lithium battery, co-intercalation of PC with lithium ion into graphite-type anode would occur. As a result, when utilizing PC, a stable solid electrolyte interface (SEI) layer cannot be formed effectively on the anode surface, thereby causing the destruction in graphite structure and the battery cannot be cycled. When suitable additives are added into the electrolyte solution, the generating effects of the SEI layer can be changed, thereby improving the performance of the lithium batteries. Currently, lithium batteries are in need of an electrolyte solution system which allows effective formation of a stable SEI layer on the anode surface to enhance the efficiency of the lithium batteries.

### SUMMARY OF THE INVENTION

The invention provides a lithium battery and an electrolyte additive used for the lithium battery. By using the electrolyte additive, the performance of the lithium battery can be effectively increased.

The lithium battery of the invention includes an anode, a cathode, a separation film, and an electrolyte solution. The cathode and the anode are disposed separately with the separation film in between the anode and the cathode. The electrolyte solution includes an organic solvent, a lithium salt, and an electrolyte additive. The electrolyte additive includes a compound represented by formula (1):

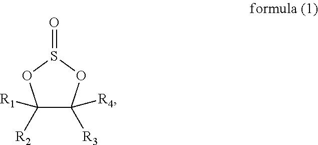

wherein R₁, R₂, R₃, and R₄ are independently a hydrogen atom, a halogen atom, or C1-C3 haloalkyl group, and at least one of R₁, R₂, R₃, and R₄ is a halogen atom or C1-C3 haloalkyl group.

In an embodiment of the invention, the electrolyte additive is a compound selected from the group of compounds represented by formula (2) to formula (11):

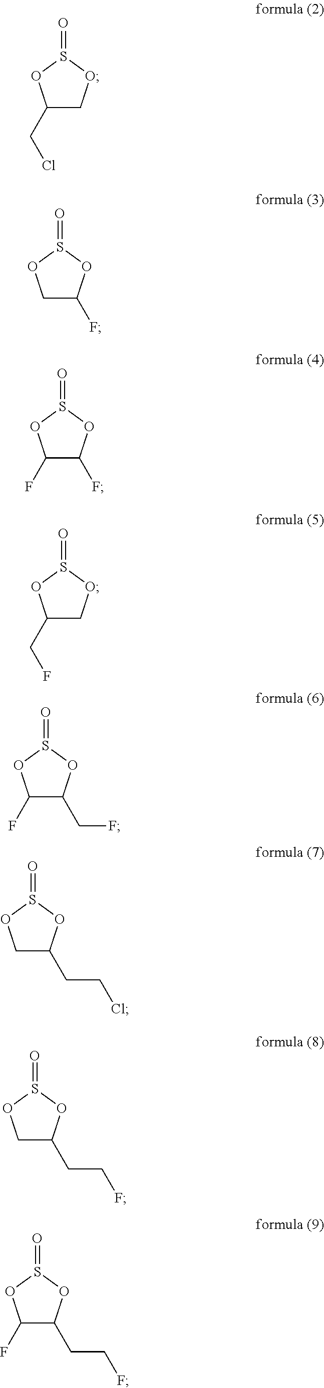

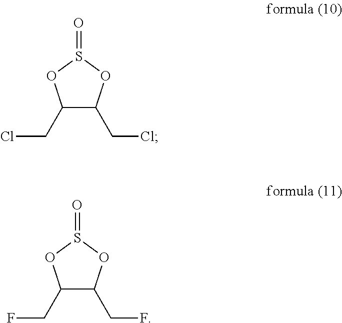 [SMILES: O=S1OC(CCl)C(CCl)O1 ; O=S1OC(CF)C(CF)O1]

In an embodiment of the invention, the amount of the electrolyte additive is 0.5 wt % to 5 wt % based on the total weight of the electrolyte solution.

In an embodiment of the invention, the organic solvent includes propylene carbonate (PC), ethylene carbonate (EC), dimethyl carbonate (DMC), diethyl carbonate (DEC), ethyl methyl carbonate (EMC), or combinations thereof.

In an embodiment of the invention, the lithium salt includes LiPF₆, LiBF₄, LiClO₄, LiAsF₆, LiSbF₆, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or combinations thereof.

In an embodiment of the invention, the material of the anode includes carbon-based material, Si-based anode material, or lithium metal.

In an embodiment of the invention, the carbon-based material includes natural graphite, artificial graphite, mesocarbon microbeads (MCMB), carbon powder, carbon fibers, carbon nanotubes, graphene, or a mixture thereof.

In an embodiment of the invention, the material of the cathode includes LiCoO₂, LiNiₓCo₁₋ₓO₂, LiFePO₄, LiMn_{1/3}Co_{1/3}Ni_{1/3}O₂, LiMn₂O₄, LiM₁ₓM_{2y}Mn_{z}O₄, wherein 0<x<1, x+y+z=2, M₁ and M₂ are divalent metal, or combinations thereof.

The electrolyte additive used for the lithium battery of the invention include a compound represented by formula (1):

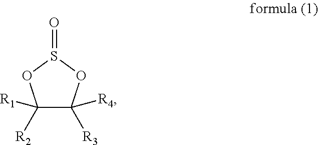

wherein R₁, R₂, R₃, and R₄ are independently a hydrogen atom, a halogen atom, or C1-C3 haloalkyl group, and at least one of R₁, R₂, R₃, and R₄ is a halogen atom or C1-C3 haloalkyl group.

In an embodiment of the invention, the electrolyte additive used for the lithium battery are a compound selected from the group of compounds represented by formula (2) to formula (11):

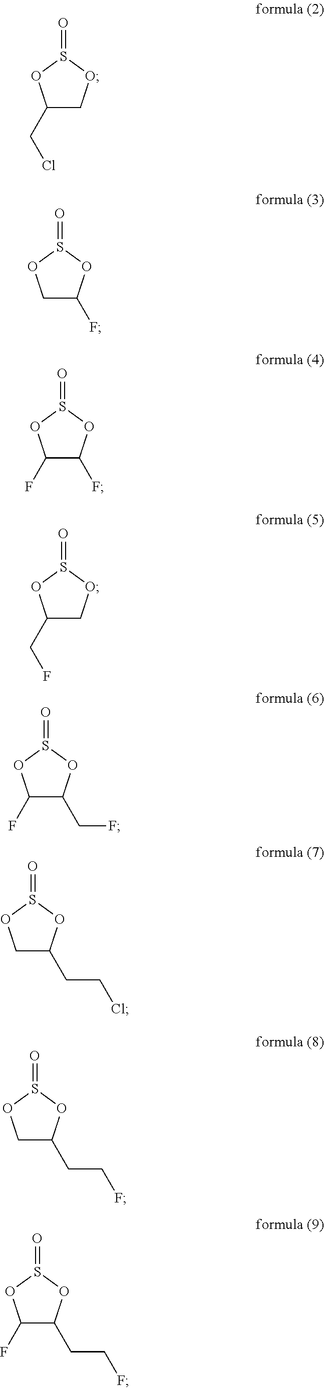

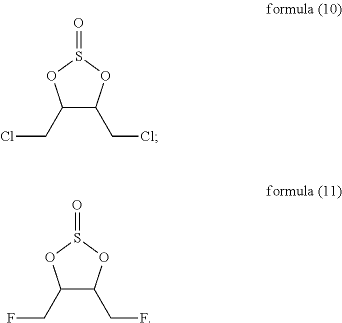 [SMILES: O=S1OC(CCl)C(CCl)O1 ; O=S1OC(CF)C(CF)O1]

Based on the above, the invention provides the lithium battery and the novel electrolyte additive used for the lithium battery. By using the lithium battery with the electrolyte additive, the damage in anode structure due to the electrolyte solution can be prevented, and the property of the lithium battery can be effectively enhanced.

To make the above features and advantages of the invention more comprehensible, several embodiments accompanied with drawings are described in detail as follows.

### BRIEF DESCRIPTION OF THE DRAWINGS

FIG. 1 is a diagram showing charge-discharge curves indicating the relationship between electric capacity and voltage according to experimental examples 1 to 4 and comparative example.

FIG. 2 is a cyclic voltammogram of lithium batteries according to experimental examples 1 to 4.

### DESCRIPTION OF THE EMBODIMENTS

In the specification, skeletal formulas are sometimes used to represent structures of compounds. Such representation can omit carbon atoms, hydrogen atoms, and carbon-hydrogen bonds. Certainly, structural formulas with clear illustrations of functional groups are definitive.

An embodiment of the invention provides a lithium battery. The lithium battery includes an anode, a cathode, a separation film, and an electrolyte solution. Specifically, the lithium battery of the invention may be any type of lithium battery known for a person having ordinary skill in the art, thus the lithium battery may further include other components such as packaging structure or the like.

The material being utilized as the anode is, for example, carbon-based material, Si-based anode material, or lithium metal. The carbon-based material being utilized as the anode is, for example, natural graphite, artificial graphite, mesocarbon microbeads (MCMB), carbon powder, carbon fibers, carbon nanotubes, graphene, or a mixture thereof. The Si-based anode material being utilized as the anode is, for example, nanowires, nanoparticles, or Si—C composite structure.

The anode and the cathode are disposed separately. The material being utilized as the cathode is, for example, lithium mixed metal oxide or lithium-excess layered oxide. The material of the cathode is, for example, LiCoO₂, LiNiₓCo₁₋ₓO₂, LiFePO₄, LiMn_{1/3}Co_{1/3}Ni_{1/3}O₂, LiMn₂O₄, LiM₁ₓM_{2y}Mn_{z}O₄, wherein 0<x<1, x+y+z=2, M₁ and M₂ are divalent metal, or combinations thereof.

The separation film is disposed between the anode and the cathode to separate the anode and the cathode. The material of the separation film is, for example, insulating material, and the insulating material may be polyethylene (PE), polypropylene (PP), or multi-layer composite of these materials, such as PP/PE/PP.

The electrolyte solution includes an organic solvent, a lithium salt, and an electrolyte additive, and the amount of the electrolyte additive is 0.5 wt % to 5 wt % based on the total weight of the electrolyte solution.

The organic solvent is, for example, propylene carbonate (PC), ethylene carbonate (EC), dialkyl carbonate, or combinations thereof. The dialkyl carbonate includes dimethyl carbonate (DMC), diethyl carbonate (DEC), or ethyl methyl carbonate (EMC). In an embodiment, the organic solvent is PC.

The lithium salt is, for example, LiPF₆, LiBF₄, LiClO₄, LiAsF₆, LiSbF₆, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or combinations thereof. In an embodiment, the lithium salt is LiPF₆.

The electrolyte additive includes a compound represented by formula (1):

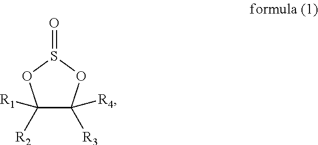

wherein R₁, R₂, R₃, and R₄ are independently a hydrogen atom, a halogen atom, or C1-C3 haloalkyl group, and at least one of R₁, R₂, R₃, and R₄ is a halogen atom or C1-C3 haloalkyl group. That is, R₁, R₂, R₃, and R₄ are not hydrogen atoms simultaneously. Specifically, the aforementioned electrolyte additive may use one kind or multiple kinds of compounds represented by formula (1).

In an embodiment, the electrolyte additive is a compound selected from the group of compounds represented by formula (2) to formula (11):

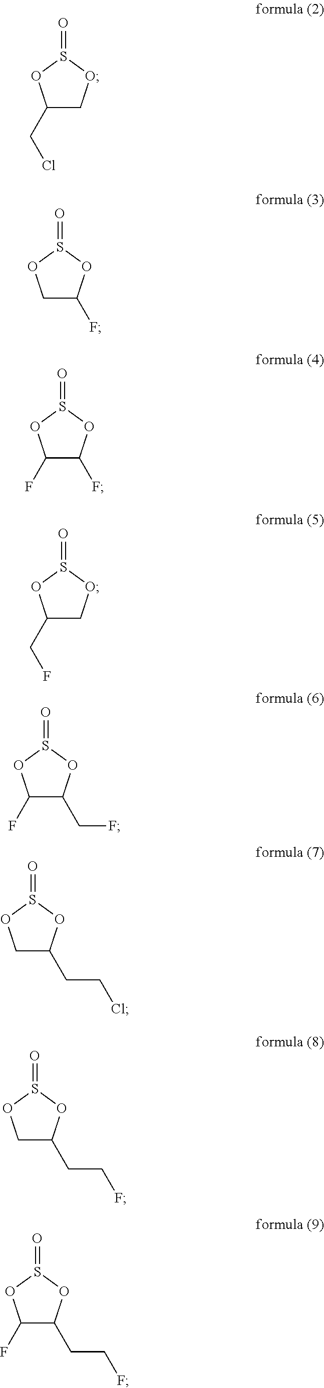

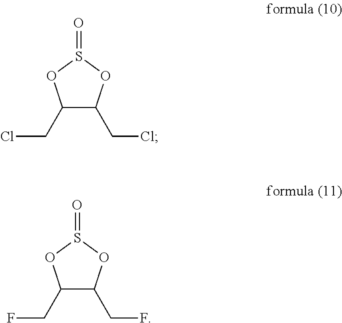 [SMILES: O=S1OC(CCl)C(CCl)O1 ; O=S1OC(CF)C(CF)O1]

In an embodiment, the electrolyte additive is the compound represented by formula (2), which is 4-chloromethyl-1,3,2-dioxathiolane 2-oxide (hereinafter referred to as “compound CMDO”).

Furthermore, in the present embodiment, as compared to the organic solvent and the lithium salt, the electrolyte additive has a high reduction potential. Therefore, before the organic solvent and the lithium salt are reacted with the anode, reduction of the electrolyte additive can take place on the anode surface to form a stable solid electrolyte interface (SEI) layer, thereby protecting the anode structure, stabilizing battery charging/discharging cycle, as well as increasing electric capacity.

### Synthesis Method of the Electrolyte Additive

The synthesis method of the compound CMDO represented by formula (2) above will be utilized as an example to explain the synthesis method of the electrolyte additive in detail below. However, it should not be construed as a limitation to the invention.

### Synthesis Example

The synthesis reaction of the compound CMDO represented by formula (2) is as follows:

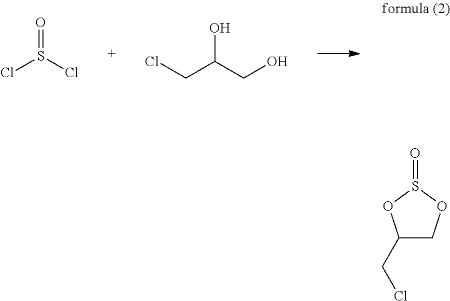

Equimolar amount of thionyl chrloeide was added drop-wise by a syringe to 1 M of 3-chloropropane-1,2-diol suspension solution using carbon tetrachloride as the solvent. Subsequently, the obtained mixture was heated and refluxed for 7 hours. Afterwards, the carbon tetrachloride was removed by low pressure evaporation-concentration method. Lastly, column chromatography with ethyl acetate/hexane (1:1) used as an eluent is performed to purify the product, thereby obtaining compound CMDO represented by formula (2) which appears to be a colorless liquid (yield 89%). ¹H NMR (500 MHz, CDCl₃) δ (ppm) 3.5-3.6 (dd, 1H, CH₂Cl), 3.6-3.7 (dd, 1H, CH₂Cl), 4.4-4.5 (dd, 1H, CH₂), 4.8 (dd, 1H, CH₂), 5.1-5.2 (m, 1H, CH). ¹²C NMR (125 MHz, CDCl₃): δ (ppm) 42 (1C, CH₂Cl), 69 (1C, CH), 78 (1C, CH₂).

Moreover, a person having ordinary skill in the art is able to understand the synthesis method of any compound represented by formula (1) based on the content disclosed in the above synthesis example. That is, a person having ordinary skill in the art is able to understand the synthesis method of compounds represented by formula (3) to formula (11) based on the content discloses in the above synthesis example.

Another embodiment of the invention provides an electrolyte additive used for a lithium battery, which includes the aforementioned electrolyte additive. In other words, the electrolyte additive used for the lithium battery includes a compound represented by formula (1):

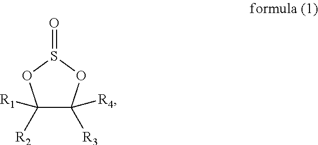

wherein R₁, R₂, R₃, and R₄ are independently a hydrogen atom, a halogen atom, or C1-C3 haloalkyl group, and at least one of R₁, R₂, R₃, and R₄ is a halogen atom or C1-C3 haloalkyl group. However, relevant descriptions and synthesis method of the electrolyte additive have been explained in detail in the foregoing embodiment, so it will not be repeated herein.

<Experiment>

The features of the invention are more specifically described in the following with reference to experimental embodiments. Although some experimental details are specifically described in the following section, the material used, the amount and ratio of each thereof, as well as the detailed process flow, etc. can be suitably modified without departing from the scope of this disclosure. Therefore, the scope of this disclosure should not be limited by the following experiments.

Experiment 1

Properties of the lithium battery and the electrolyte additive used for the lithium battery provided in the foregoing embodiments will be demonstrated in detail through experimental examples 1 to 4 and comparative example below.

### Experimental Example 1

### Preparation of Electrolyte Solution

Propylene carbonate (PC) as the organic solvent, LiPF₆ as the lithium salt with a concentration of 1 M, and 0.5 wt % of the compound CMDO represented by formula (2) as the electrolyte additive were being mixed to obtain an electrolyte solution of experimental example 1.

### Fabrication of Lithium Battery

A 2032 type coin half cell was assembled. In the 2032 type coin half cell, mesocarbon microbeads (MCMB) was utilized as the anode, the lithium metal foil was utilized as counter electrode, the electrolyte solution of experimental example 1 was utilized as the electrolyte solution, and the polypropylene/polyethylene/polypropylene (PP/PE/PP) triple-layer film (Product name Celgard 2325) was utilized as the separation film. Herein, the lithium battery of experimental example 1 has been fabricated.

### Experimental Example 2

The difference between the lithium battery of experimental example 2 and the lithium battery of experimental example 1 is that the compositions of the electrolyte solution in two experimental examples are different. Specifically, the only difference between the electrolyte solution of experimental example 2 and the electrolyte solution of experimental example 1 is that in experimental example 2, the amount of the compound CMDO represented by formula (2) (utilized as the electrolyte additive) is 1 wt %. Other than the difference, the preparation method of the electrolyte solution and the fabrication method of the lithium battery are identical as experimental example 1.

### Experimental Example 3

The difference between the lithium battery of experimental example 3 and the lithium battery of experimental example 1 is that the compositions of the electrolyte solution in two experimental examples are different. Specifically, the only difference between the electrolyte solution of experimental example 3 and the electrolyte solution of experimental example 1 is that in experimental example 3, the amount of the compound CMDO represented by formula (2) (utilized as the electrolyte additive) is 2 wt %. Other than the difference, the preparation method of the electrolyte solution and the fabrication method of the lithium battery are identical as experimental example 1.

### Experimental Example 4

The difference between the lithium battery of experimental example 4 and the lithium battery of experimental example 1 is that the compositions of the electrolyte solution in two experimental examples are different. Specifically, the only difference between the electrolyte solution of experimental example 4 and the electrolyte solution of experimental example 1 is that in experimental example 4, the amount of the compound CMDO represented by formula (2) (utilized as the electrolyte additive) is 5 wt %. Other than the difference, the preparation method of the electrolyte solution and the fabrication method of the battery are identical as experimental example 1.

### Comparative Example

The difference between the lithium battery of comparative example and the lithium battery of experimental example 1 is that the compositions of the electrolyte solution in two experimental examples are different. Specifically, the only difference between the electrolyte solution of comparative example and the electrolyte solution of experimental example 1 is that in the comparative example, no electrolyte additive is being utilized. Other than the difference, the preparation method of the electrolyte solution and the fabrication method of the battery are identical as experimental example 1.

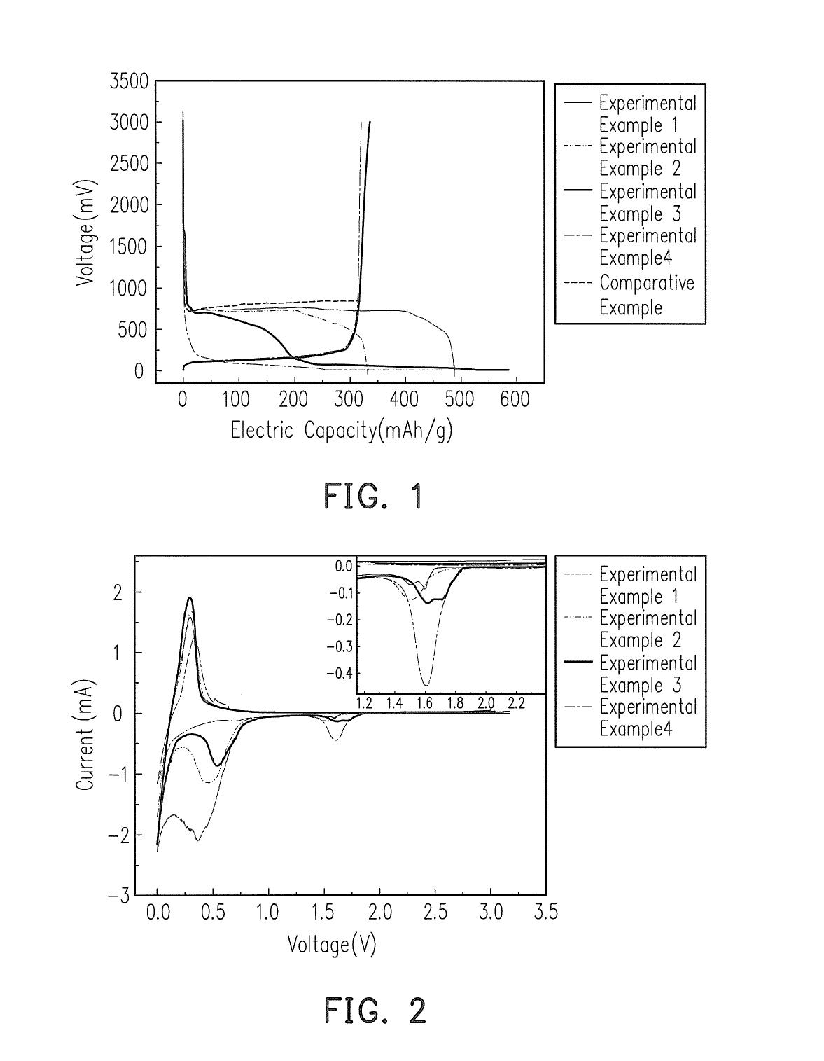

Subsequently, the charging/discharging performance and electrochemical property of the lithium batteries of experimental examples 1 to 4 and comparative example were being tested. The resulting measurements are respectively shown in FIG. 1 and FIG. 2.

### <Charging/Discharging Performance Test>

The lithium batteries of experimental examples 1 to 4 and comparative example were respectively charged and discharged between 3 V and 10 mV at a rate of 0.1 C. FIG. 1 is a diagram showing relationship curves between electric capacity and voltage according to experimental examples 1 to 4 and comparative example.

As shown in FIG. 1, the lithium battery without using any electrolyte additives according to comparative example does not have charging/discharging ability. The lithium batteries respectively being added with 0.5 wt % and 1 wt % of compound CMDO represented by formula (2) (electrolyte additive) according to experimental example 1 and experimental example 2 have charging ability. The lithium batteries respectively being added with 2 wt % and 5 wt % of compound CMDO represented by formula (2) (electrolyte additive) according to experimental example 3 and experimental example 4 have charging/discharging ability. In other words, through the addition of compound CMDO represented by formula (2) used as the electrolyte additive in the electrolyte solution, the mesocarbon microbeads (MCMB) would not be damaged by propylene carbonate (PC) and lithium ion, thereby allowing lithium battery which originally does not encompass charging/discharging ability to be able to perform charging/discharging function.

The results confirmed that, by adding compound CMDO represented by formula (2) into the electrolyte solution, the damage in mesocarbon microbeads (MCMB) by propylene carbonate (PC) and lithium ion can be successfully prevented. As such, the lithium battery can encompass excellent electric capacity and battery efficiency, and these advantageous properties are further enhanced with the increasing amount of the electrolyte additive.

### <Electrochemical Property Test>

A cyclic voltammetric method was performed on the lithium batteries according to experimental examples 1 to 4 by a potentiostat. Cyclic voltammograms scanning was performed at a scan rate of 0.1 mV/sec between the potential range of 3 V to 0V. FIG. 2 is a cyclic voltammogram of lithium batteries according to experimental examples 1 to 4.

As shown in FIG. 2, a reduction current peak is located near a potential of 1.6 V. The reduction current peak represents that the reduction of the compound CMDO represented by formula (2) takes place on the surface of mesocarbon microbeads (MCMB) to form the SEI layer. That is, the reduction potential of the compound CMDO represented by formula (2) is approximately 1.6 V.

Furthermore, the results confirmed that prior to the co-intercalation of PC with lithium ion into MCMB (having a reduction potential of approximately 0.5 V), the compound CMDO (having a reduction potential of approximately 1.6 V) represented by formula (2) is able to form the SEI layer effectively on the surface of the anode, thereby successfully preventing the damage in MCMB by PC and lithium ion. As such, the lithium battery can encompass excellent electric capacity and battery efficiency.

Experiment 2

The theoretical calculations of highest occupied molecular orbital (HOMO), lowest unoccupied molecular orbital (LUMO), electron affinity (EAᵥ), ionization potential (IPᵥ), chemical hardness, dipole moment, and reduction potential were performed with the high-throughput screening method using the Material Studio module software. The calculated results are shown in Table 1.

TABLE 1

| | | | | | Chemi- | | |
|---|---|---|---|---|---|---|---|
| | | | | | cal | Dipole | |
| | HOMO | LUMO | EAᵥ | IPᵥ | Hard- | Moment | E_{red} |
| | (eV) | (eV) | (eV) | (eV) | ness | (D) | (V) |
| Compound | −8.29 | −1.43 | 3.51 | 7.92 | 2.20 | 4.53 | 1.66 |
| Represented | | | | | | | |
| by Formula | | | | | | | |
| (2) | | | | | | | |
| Compound | −8.66 | −1.73 | 4.03 | 8.19 | 2.08 | 4.00 | 2.20 |
| Represented | | | | | | | |
| by Formula | | | | | | | |
| (3) | | | | | | | |
| Compound | −8.91 | −2.11 | 4.19 | 8.52 | 2.16 | 3.69 | 2.37 |
| Represented | | | | | | | |
| by Formula | | | | | | | |
| (4) | | | | | | | |
| Compound | −8.41 | −1.40 | 3.43 | 7.95 | 2.26 | 4.48 | 1.58 |
| Represented | | | | | | | |
| by Formula | | | | | | | |
| (5) | | | | | | | |
| Compound | −8.70 | −1.86 | 4.05 | 8.25 | 2.1 | 1.94 | 2.20 |
| Represented | | | | | | | |
| by Formula | | | | | | | |
| (6) | | | | | | | |
| Compound | −8.15 | −1.29 | 3.27 | 6.80 | 1.77 | 7.42 | 1.42 |
| Represented | | | | | | | |
| by Formula | | | | | | | |
| (7) | | | | | | | |
| Compound | −8.26 | −1.28 | 3.26 | 7.81 | 2.28 | 7.39 | 1.41 |
| Represented | | | | | | | |
| by Formula | | | | | | | |
| (8) | | | | | | | |
| Compound | −8.56 | −1.75 | 3.95 | 8.14 | 2.10 | 4.39 | 2.10 |
| Represented | | | | | | | |
| by Formula | | | | | | | |
| (9) | | | | | | | |
| Compound | −8.33 | −1.54 | 3.43 | 7.82 | 2.25 | 4.66 | 1.55 |
| Represented | | | | | | | |
| by Formula | | | | | | | |
| (10) | | | | | | | |
| Compound | −8.49 | −1.51 | 3.46 | 8.03 | 2.29 | 4.83 | 1.63 |
| Represented | | | | | | | |
| by Formula | | | | | | | |
| (11) | | | | | | | |

As shown in Table 1, as compared to the commonly known additives such as ethylene sulfite (ES) and the commonly used organic solvents in electrolyte solutions such as propylene carbonate (PC), the compounds represented by formula (2) to formula (11) all have higher dipole moment, lower chemical hardness, and lower LUMO. In addition, as shown in Table 1, the reduction potential of each of the compounds represented by formula (2) to formula (11) is approximately range from 1.41 V to 2.37 V. In view of foregoing, the compounds represented by formula (2) to formula (11) are suitable to be used in a lithium battery system in which mesocarbon microbeads (MCMB) is being utilized as the anode and propylene carbonate being utilized as the organic solvent of the electrolyte solution. In detail, these compounds allow the formation of a stable SEI layer on the surface of the MCMB after charging.

Accordingly, the electrolyte additive used for the lithium battery provided in the foregoing embodiments is a novel electrolyte additive. Moreover, the electrolyte additive used for the lithium battery provided in the foregoing embodiments is able to form a stable SEI layer on the surface of the anode after charging, thereby preventing damages in anode structure due to the electrolyte solution and effectively enhancing the property of the lithium battery.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A lithium battery, comprising:
an anode;
a cathode, disposed separately from the anode;
a separation film, disposed between the anode and the cathode; and
an electrolyte solution, the electrolyte solution comprises an organic solvent, a lithium salt, and an electrolyte additive, and the electrolyte additive comprises a compound represented by formula (1): 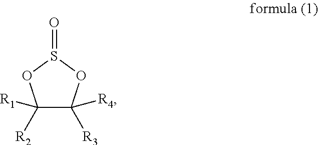
wherein R₁, R₂, R₃, and R₄ are independently a hydrogen atom, a halogen atom, or C1-C3 haloalkyl group, and at least one of R₁, R₂, R₃, and R₄ is a halogen atom or C1-C3 haloalkyl group.

2. The lithium battery according to claim 1, wherein the electrolyte additive is a compound selected from the group of compounds represented by formula (2) to formula (11):

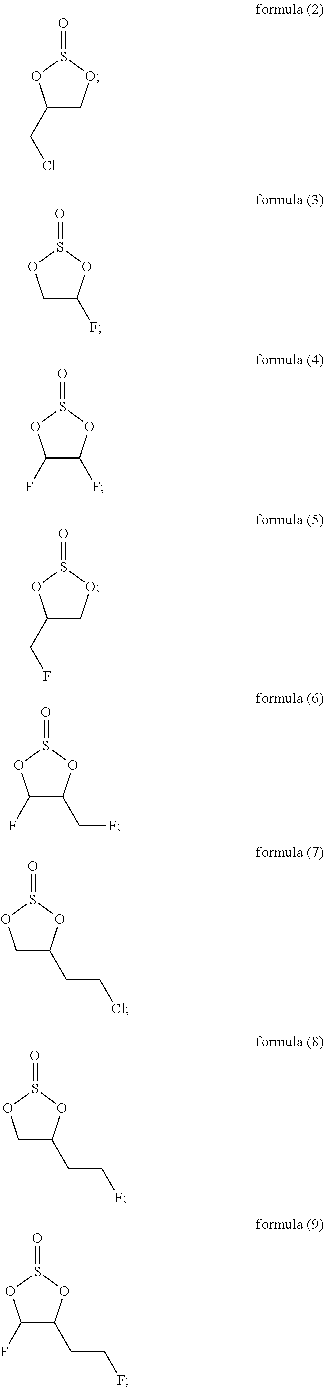

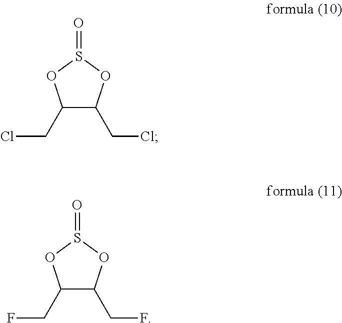 [SMILES: O=S1OC(CCl)C(CCl)O1 ; O=S1OC(CF)C(CF)O1]

3. The lithium battery according to claim 1, wherein an amount of the electrolyte additive is 0.5 wt % to 5 wt % based on the total weight of the electrolyte solution.

4. The lithium battery according to claim 1, wherein the organic solvent comprises propylene carbonate (PC), ethylene carbonate (EC), dimethyl carbonate (DMC), diethyl carbonate (DEC), ethyl methyl carbonate (EMC), or combinations thereof.

5. The lithium battery according to claim 1, wherein the lithium salt comprises LiPF₆, LiBF₄, LiClO₄, LiAsF₆, LiSbF₆, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or combinations thereof.

6. The lithium battery according to claim 1, wherein a material of the anode comprises carbon-based material, Si-based anode material, or lithium metal.

7. The lithium battery according to claim 6, wherein the carbon-based material comprises natural graphite, artificial graphite, mesocarbon microbeads (MCMB), carbon powder, carbon fibers, carbon nanotubes, graphene, or a mixture thereof.

8. The lithium battery according to claim 1, wherein a material of the cathode comprises LiCoO₂, LiNiₓCo₁₋ₓO₂, LiFePO₄, LiMn_{1/3}Co_{1/3}Ni_{1/3}O₂, LiMn₂O₄, LiM₁ₓN_{2y}Mn_{z}O₄, wherein 0<x<1, x+y+z=2, M₁ and M₂ are divalent metal, or combinations thereof.

9. An electrolyte additive used for a lithium battery, comprising a compound represented by formula (1): 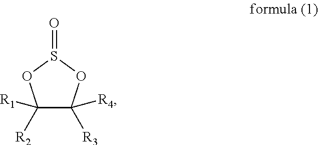
wherein R₁, R₂, R₃, and R₄ are independently a hydrogen atom, a halogen atom, or C1-C3 haloalkyl group, and at least one of R₁, R₂, R₃, and R₄ is a halogen atom or C1-C3 haloalkyl group.

10. The electrolyte additive used for the lithium battery according to claim 9, wherein the electrolyte additive used for the lithium battery is a compound selected from the group of compounds represented by formula (2) to formula (11): 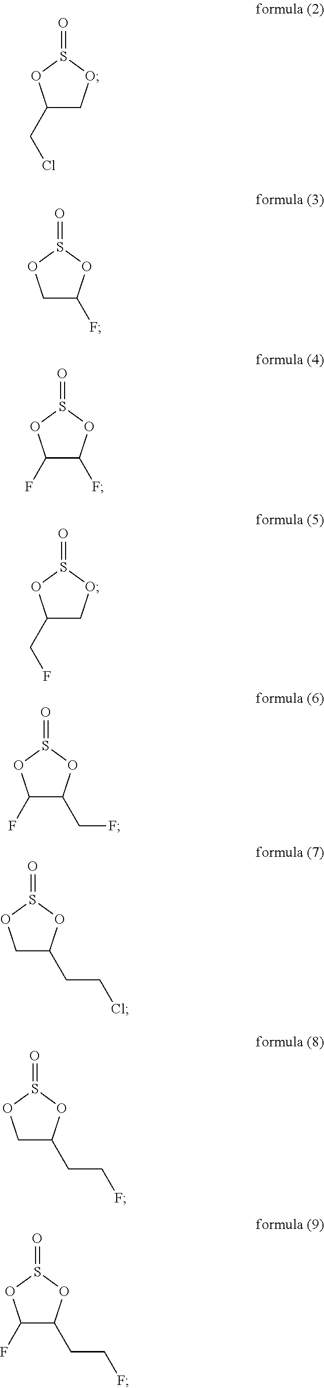 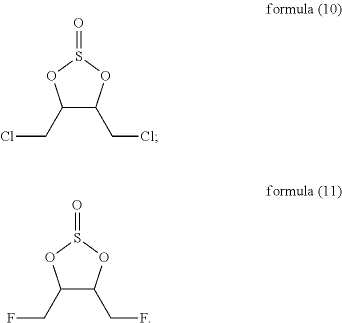 [SMILES: O=S1OC(CCl)C(CCl)O1 ; O=S1OC(CF)C(CF)O1]
